(19) United States
(12) Patent Application Publication
(10) Pub. No.: US 2009/0224044 A1
(43) Pub. Date: Sep. 10, 2009

(54) Electronic register

(76) Inventor: Henry Gonzalez, San Antonio, TX (US)

Correspondence Address: David E. Orr, 4616 NE 134th Street, Vancouver, WA, 98686, US

(21) Appl. No.: 12/074,520

(22) Filed: Mar. 5, 2008

(51) Int. Cl. G06K 7/01

(52) U.S. Cl. 235/439

(57) ABSTRACT

An electronic device for keeping track of electronic transactions involving the use of credit and debit cards is disclosed. An exemplary embodiment is disclosed as a pocket-sized device having memory and processing logic. The device includes a visual display, a card reader and a keypad. Each time the card is used, the magnetic stripe of the card is read by the device. The user may enter data by means of the keypad. Keypad entry may include search arguments for querying debit and credit balances, or may be data related to tractions. The display may display data stored in the devices memory or data read from the card. Accounting information for multiple cards may be maintained by the device.

### FIELD

The present invention relates to devices for supporting banking transactions; more specifically the present invention is an electronic register for credit and debit cards.

### BACKGROUND

A credit card is a system of payment named after the small plastic card issued to users of the system. A credit card is different from a debit card in that it does not remove money from the user's account after every transaction. In the case of credit cards, the issuer lends money to the consumer (or the user) to be paid to the merchant. It is also different from a charge card (though this name is sometimes used by the public to describe credit cards), which requires the balance to be paid in full each month. In contrast, a credit card allows the consumer to ‘revolve’ their balance, at the cost of having interest charged. Most credit cards are the same shape and size, as specified by the ISO 7810 standard.

A debit card is a plastic card which provides an alternative payment method to cash when making purchases. Physically the card is an ISO 7810 card like a credit card; however, its functionality is more similar to writing a check as the finds are withdrawn directly from either the cardholder's bank account (often referred to as a check card), or from the remaining balance on a gift card.

Depending on the store or merchant, the customer may swipe or insert their card into the terminal, or they may hand it to the merchant who will do so. The transaction is authorized and processed and the customer verifies the transaction either by entering a PIN or, occasionally, by signing a sales receipt.

In some countries the debit card is multipurpose, acting as the ATM card for withdrawing cash and as a check guarantee card. Merchants can also offer “cashback”/“cashout” facilities to customers, where a customer can withdraw cash along with their purchase.

The use of debit cards has become wide-spread in many countries and has overtaken the check, and in some instances cash transactions by volume. Like credit cards, debit cards are used widely for telephone and Internet purchases. This ^{[citation needed]} may cause inconvenient delays at peak shopping times (e.g. the last shopping day before Christmas), caused when the volume of transactions overloads the bank networks.

More than 300 million credits are active in the United States and more than 50 million debit cards are used. More than a billion credit cards are in the hands of consumers throughout the world.

What is needed and has not yet been provided is a means for a user to keep track of card usage as it occurs.

### OBJECTS

Therefore as a means of providing a user a means for keeping track of card usage, herein is disclosed, in an exemplary embodiment of the invention, a device that registers usage of both credit and debit cards. The invention has been made according to the object of a device that is small, portable and may be carried by the card user.

A second object and benefit is a device that reads credit and debit cards, precluding the necessity of the user manually recording the card number when it is used.

A third object and benefit of the invention is device that is electronically coupled to a credit or debit card, and notifies the user when the card is separated from the device, thereby assisting the user to not lose the card.

A fourth object and benefit is a device that may keep or carry the card.

A fifth object and benefit of the invention is a device that alerts the user when credit or debit limits are exceeded.

An yet another object is a device that may keep track of the use of multiple cards.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In an exemplary embodiment, an electronic device for keeping track of electronic transactions involving the use of credit and debit cards. The exemplary embodiment is disclosed as a pocket-sized device having memory and processing logic. The device further includes a visual display, a card reader and a keypad. Each time the card is used, the magnetic stripe of the card is read by the device. The user may enter data by means of the keypad. Keypad entry may include search arguments for querying debit and credit balances, or may be data related to transactions. The display may display data stored in the devices memory or data read from the card.

### BRIEF DESCRIPTION OF DRAWINGS

FIG. 1 illustrates a possible processor and storage that may be implemented within the device.

FIG. 2A shows a configuration of the exemplary embodiment of the device.

FIG. 2B shows components of the device.

FIG. 2C illustrates the device reading a credit or debit card.

FIG. 2D shows the magnetic stripe of a credit or debit card.

### DETAILED DESCRIPTION

### An Exemplary Embodiment

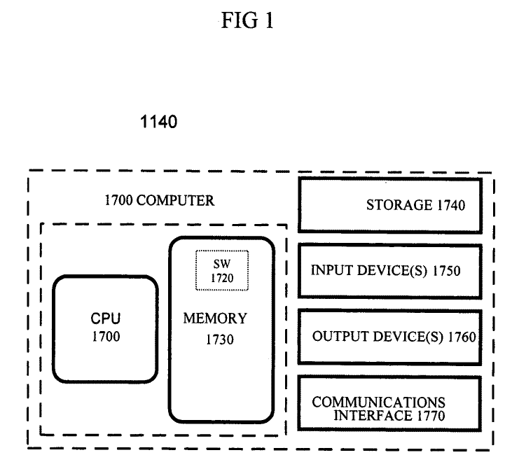

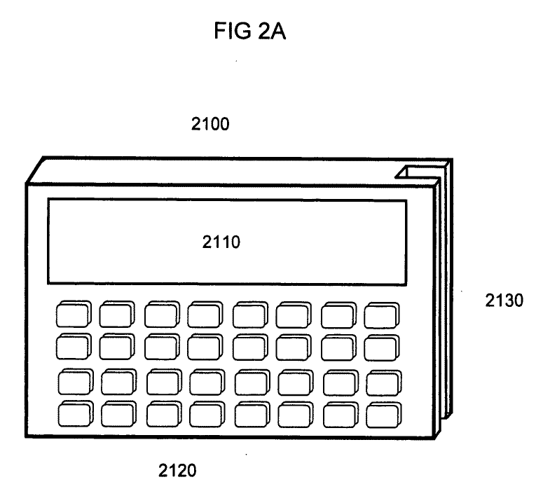

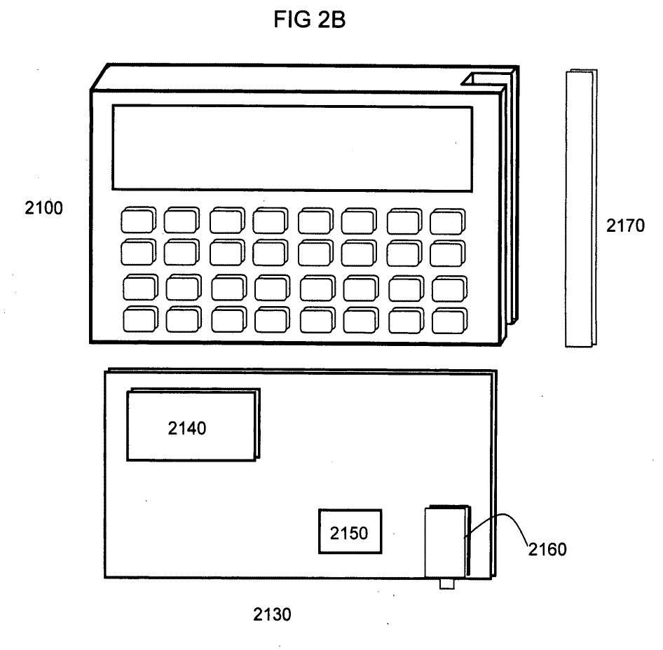

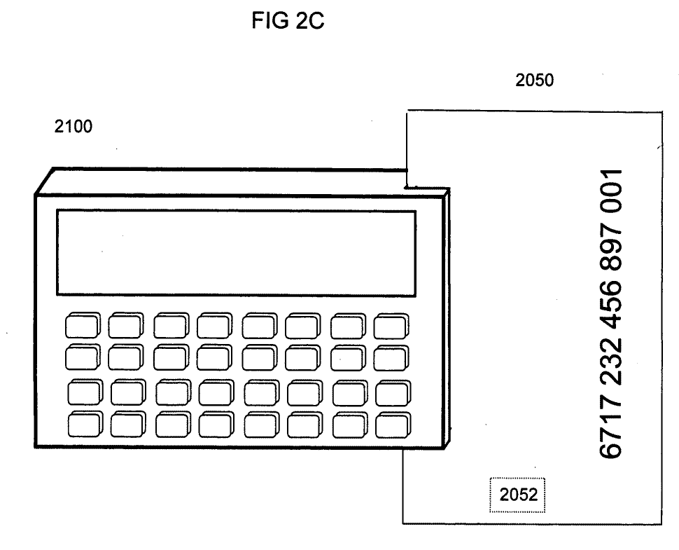

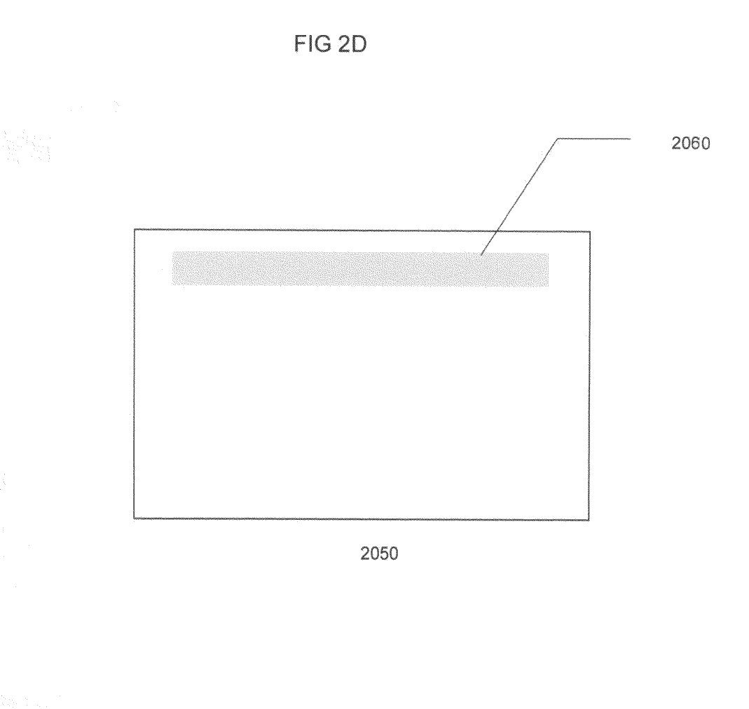

With reference to FIG. 1, FIG. 2A, FIG. 2B, and FIG. 2C, an exemplary embodiment of the invention is disclosed.

The following description provides a context for technology used in the exemplary embodiment of the invention.

### Technology for Encoding and Reading Credit and Debit Cards

A magnetic stripe reader, also called a “magstripe” reader, is a hardware device that reads the information encoded in the magnetic stripe located on the back of a plastic badge. Magnetic stripe readers can be read by a computer program through a serial port, USB connection, or keyboard wedge, and are generally categorized by the way they read a magnetic card. For instance, insertion readers require that the card be inserted into the reader and then pulled out. Swipe readers require that the card pass completely through the reader.

The magnetic stripe on the back of a card is composed of iron-based magnetic particles encased in plastic-like tape. Each magnetic particle in the stripe is a tiny bar magnet about 20-millionths of an inch long. When all bar magnets are polarized in the same direction, the magnetic stripe is blank. Information is written on the stripe by magnetizing the tiny bars in either a north or south-pole direction with a special electromagnetic writer, called an encoder. The writing process, called flux reversal, causes a change in the magnetic field that can be detected by the magnetic stripe reader. Since there can be two different flux reversals, N-N or S-S, there can be two different information states, much like the binary system used by computers. The magnetic stripe reader reads the information by detecting the changes in the magnetic field caused by the flux reversals on the badge's magnetic stripe.

### RFID

RFID (radio frequency identification) is a technology that incorporates the use of electromagnetic or electrostatic coupling in the radio frequency (RF) portion of the electromagnetic spectrum to uniquely identify an object. RFID is gaining in use in industry as an alternative to the bar code. The advantage of RFID is that it does not require direct contact or line-of-sight scanning. An RFID system consists of three components: an antenna and transceiver (often combined into one reader) and a transponder (the tag). The antenna uses radio frequency waves to transmit a signal that activates the transponder. When activated, the tag transmits data back to the antenna. The data is used to notify a programmable logic controller that an action should occur. The action could be as simple as raising an access gate or as complicated as interfacing with a database to carry out a monetary transaction. Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (more than 90 feet). In general, the higher the frequency, the more expensive the system.

### Passive RFID Tags

Passive RFID tags have no internal power supply. The minute electrical current induced in the antenna by the incoming radio frequency signal provides just enough power for the CMOS integrated circuit (IC) in the tag to power up and transmit a response. Most passive tags signal by backscattering the carrier signal from the reader. This means that the aerial (antenna) has to be designed to both collect power from the incoming signal and also to transmit the outbound backscatter signal. The response of a passive RFID tag is not just an ID number (GUID); the tag chip can contain nonvolatile EEPROM for storing data. Lack of a power supply means that the device can be quite small: commercially available products exist that can be embedded under the skin. As of 2006, the smallest such devices measured 0.15 mm×0.15 mm, and are thinner than a sheet of paper (7.5 micrometers). The addition of the antenna creates a tag that varies from the size of postage stamp to the size of a post card. Passive tags have practical read distances ranging from about 2 mm (ISO 14443) up to a few meters (EPC and ISO 18000-6) depending on the chosen radio frequency and antenna design/size. Due to their simplicity in design they are also suitable for manufacture with a printing process for the antennas. Passive RFID tags do not require batteries, can be much smaller, and have an unlimited life span.

### Semi-Passive RFID Tags

Semi-passive RFID tags are similar to passive tags except for the addition of a small battery. This battery allows the tag IC to be constantly powered, which removes the need for the aerial to be designed to collect power from the incoming signal. Aerials can therefore be optimized for the backscattering signal. Semi-passive RFID tags are thus faster in response, though less reliable and powerful than active tags.

### Active RFID Tags

Unlike passive RFID tags, active RFID tags have their own internal power source which is used to power any ICs that generate the outgoing signal. Active tags are typically much more reliable (e.g. fewer errors) than passive tags due to the ability for active tags to conduct a communications session with a reader. Active tags, with their onboard power supply, also transmit at higher power levels than passive tags, allowing them to be more effective in “RF challenged” environments, or at longer distances. Many active tags have practical ranges of hundreds of meters, and a battery life of up to 10 years. Some active RFID tags include sensors such as temperature logging. Other sensors that have been married with active RFID include humidity, shock/vibration, light, radiation, temperature and atmospherics. Active tags typically have much longer range (approximately 300 feet) and larger memories than passive tags, as well as the ability to store additional information sent by the transceiver. At present, the smallest active tags are about the size of a coin and sell for a few dollars.

### RFID Systems

In a typical RFID system, individual objects are equipped with a small, inexpensive tag. The tag contains a transponder with a digital memory chip that is given a unique electronic product code. The interrogator, an antenna packaged with a transceiver and decoder, emits a signal activating the RFID tag so it can read and write data to it. When an RFID tag passes through the electromagnetic zone, it detects the reader's activation signal. The reader decodes the data encoded in the tag's integrated circuit (silicon chip) and the data is passed to the host computer. The application software on the host processes the data, often employing Physical Markup Language (PML).

Consider, for example, securing books in a library. Security gates can detect whether or not a book has been properly checked out of the library. When users return items, the security bit is re-set and the item record in the library computer system is automatically updated. In some RFID solutions a return receipt can be generated. At this point, materials can be roughly sorted into bins by the return equipment.

### LCD

LCD (liquid crystal display) is the technology used for displays in notebook and other smaller computers. Like light-emitting diode (LED) and gas-plasma technologies, LCDs allow displays to be much thinner than cathode ray tube (CRT) technology. LCDs consume much less power than LED and gas-display displays because they work on the principle of blocking light rather than emitting it.

An LCD is made with either a passive matrix or an active matrix display display grid. The active matrix LCD is also known as a thin film transistor (TFT) display. The passive matrix LCD has a grid of conductors with pixels located at each intersection in the grid. A current is sent across two conductors on the grid to control the light for any pixel. An active matrix has a transistor located at each pixel intersection, requiring less current to control the luminance of a pixel. For this reason, the current in an active matrix display can be switched on and off more frequently, improving the screen refresh time (your mouse will appear to move more smoothly across the screen, for example). Some passive matrix LCD's have dual scanning, meaning that they scan the grid twice with current in the same time that it took for one scan in the original technology. However, active matrix is still a superior technology.

Now follows a description of a computing environment for use in the device, in the form of IC (integrated circuit) chips, ASICs (application specific integrated circuits) of FPGAs (field programmable gate arrays.)

### Computing Environment

With reference to FIG. 1, control of the device may be implemented; for example, within a computing environment 1140, which includes at least one processing unit 1700 and memory 1730. In FIG. 1, this most basic configuration 1140 is included within a dashed line. The processing unit 1700 executes computer-executable instructions and may be a real or a virtual processor. In a multi-processing system, multiple processing units execute computer-executable instructions to increase processing power. The memory 1730 may be volatile memory (e.g., registers, cache, RAM), non-volatile memory (e.g., ROM, EEPROM, flash memory, etc.), or some combination of the two. The memory 1730 stores executable software—instructions and data 1720—written and operative to execute and implement the software applications required for an interactive environment supporting practice of the invention.

The computing environment may have additional features. For example, the computing environment 1140 includes storage 1740, one or more input devices 1750, one or more output devices 1760, and one or more communication connections or interfaces 1770. An interconnection mechanism (not shown) such as a bus, controller, or network interconnects the components of the computing environment, for example with servo-mechanisms and sensor devices too sense and control metering pumps, and valves for storing and releasing constituents into and from mixers, and concrete plant dispensing equipment. Typically, operating system software (not shown) provides an operating environment for other software executing in the computing environment, and coordinates activities of the components of the computing environment.

The storage 1740 may be removable or non-removable, and includes magnetic disks, CD-ROMs, DVDs, or any other medium which can be used to store information and which can be accessed within the computing environment. For example, the storage may store credit or debit balances, limits, and past transactions. The storage 1740 also stores instructions for the software 1720, and is configured, for example, to store signal processing algorithms, databases storing concrete formulations, database software systems, intermediate results and data generated from sensor inputs. The database includes at least one record having data related to a transaction.

The input device(s) 1750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 1760 may be a display, printer, speaker, or another device that provides output from the computing environment.

The communication interface 1770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 1770 is used to communicate with other devices such as cards or ATMs having RFID devices. For example, the interface 1770 may be attached to a network, such as the Internet, whereby the computing environment 1140 interchanges command, control and feedback signals with other computers, devices, and machinery.

FIG. 2B illustrates the use of the computing environment shown if FIG. 1. In FIG. 2B, the computer system 2700 though the communication interface having an RFID reader 2150, and a transmitter 2774 may receive and transmits signals to and from communications devices.

### Operation of the Device

FIG. 2B illustrates the primary components of the exemplary embodiment. In FIG. 2B, the device 2100 comprises a storage-logic component 2130, and a magnetic strip reader 2170. The storage-logic component has an RFID reader 2150, and a rechargeable power supply 2160. The memory-logic component 2130 comprises a chip 2140 implementing the processing environment disclosed above and shown in FIG. 1.

FIG. 2A further shows the device 2100 having an LCD display 2110, a keypad 2120 and a slot 2130 for passing the stripe of a magnetic card.

FIG. 2C shows the device 2100 reading a card 2050 having a magnetic stripe (on the back and not shown.) The card 2050 is shown having an embedded RFID 2052 that is activated by the RFID reader in the device (shown as 2150 in FIG. 2B.) The device 2100 reads data from the magnetic stripe of the card 2050, when the card is swiped in the device 2100.

Programmed logic in the storage-logic component 2130 polls the RFID 2052 embedded in the card 2050. As long as the RFID reader 2150 is capable of reading the RFID chip 2052, the device remains silent, but upon losing communications with the RFID 2052 on the card 2050, the device 2100 sounds or flashes an alarm.

### Accounting for Transactions and Multiple Cards

With reference to FIG. 2D, a credit or debit card 2050 is shown with a magnetic stripe 2060. The magnetic stripe 2060 on the back of the credit or debit card 2050 is composed of iron-based magnetic particles encased in plastic-like tape. Each magnetic particle in the stripe 2060 is a tiny bar magnet about 20-millionths of an inch long. When all bar magnets are polarized in the same direction, the magnetic stripe is blank. Information is written on the stripe by magnetizing the tiny bars in either a north or south direction with a special electromagnetic writer, called an encoder. The writing process, called flux reversal, causes a change in the magnetic field that can be detected by the magnetic stripe reader. Since there can be two different flux reversals, N-N or S-S, there can be two different information states, much like the binary system used by computers. A magnetic stripe reader reads the information by detecting the changes in the magnetic field caused by the flux reversals on the card's magnetic stripe 2060.

The magnetic stripe 2060 may be read and written by various terminals, such as ATMs at banks and various other places of business. For example, when a credit card is used to purchase an item, the stripe 2060 is read, and data encoded in the stripe 2060 may be changed or updated.

By reading data from the magnetic stripe 2060, which contains both static and dynamic data, the device 2100 (see FIG. 2C) is able to determine account information stored in the card 2050. Account information obtained from the card may be stored in the device 2100 shown in FIG. 2C, and therefore is able to track status and changes in status of multiple credit and debit cards.

### DISCLUSURE SUMMARY

An electronic device for keeping track of electronic transactions involving the use of credit and debit cards has been disclosed. An exemplary embodiment has been disclosed as a pocket-sized device having memory and processing logic. The device further includes a visual display, a card reader and processing logic and storage. In view of the present disclosure, other variations and alterations may be conceived, which are incorporated in the claims that follow.

1. (canceled)

2. A portable device for carrying, communicating with and registering the use of a credit or debit card, the device including circuitry and logic for monitoring the proximity of the card and for reading the card to store information related to card usage.

3. The device of claim 1, wherein the device has a first radio frequency identifier, communicates with the card by a second radio frequency identifier in the card, the device emitting an alarm when the device cannot communicate with card.

4. The device of claim 2, wherein the device has a magnetic reader and stores information read from a magnetic strip on the card.
